(19) United States
(12) Patent Application Publication
(10) Pub. No.: US 2010/0255739 A1
(43) Pub. Date: Oct. 7, 2010

(54) ROOFING MEMBRANE

(75) Inventors: Cary K. Black, Freeland, MI (US); John R. Scott, Frankenmuth, MI (US)

Correspondence Address: REISING ETHINGTON P.C., P O BOX 4390, TROY, MI, 48099-4390, US

(73) Assignee: Duro-Last, Inc., Saginaw, MI (US)

(21) Appl. No.: 12/753,303

(22) Filed: Apr. 2, 2010

Related U.S. Application Data
(60) Provisional application No. 61/166,522, filed on Apr. 3, 2009.

(51) Int. Cl. B32B 27/18; B32B 27/12; B32B 27/36; E04D 5/00; B32B 27/32; C08L 23/16; C08K 3/22

(52) U.S. Cl. 442/46; 442/43; 525/240; 524/528; 524/436

(57) ABSTRACT

A roofing membrane having a membrane composition including a propylene based elastomer, a plastomer, and an impact polypropylene-ethylene copolymer. The membrane composition also may have a flame retardant. In a related exemplary embodiment, the total weight percent of polypropylene-ethylene copolymer present in the composition may range from about 7 to 20 percent.

### CROSS-REFERENCE TO RELATED APPLICATION

This application claims the benefit of U.S. Provisional Application No. 61/166,522, filed Apr. 3, 2009. The content of the above application is incorporated herein by reference in its entirety.

### TECHNICAL FIELD

The technical field generally relates to roofing materials and, more particularly, to a flexible synthetic roofing membrane.

### BACKGROUND

Single-ply membrane sheet roofing systems are very well recognized and widely in use as both new and renovated exterior roof surfaces for a multiplicity of building structures having generally flat roof decks. Certain manufacturers prefabricate custom roofing sheets to the exact dimensions of the building roof in rolled transportable sections of up to 2500 square feet to the roofer on site. Other single-ply roofs are largely worker-constructed at the site and bonded by the roofer on the site. A number of such roofing systems are utilized for large footprint roofs, such as factories, administrative buildings, schools, and office buildings, for example.

### SUMMARY

According to one embodiment, there is provided a roofing membrane having a membrane composition including a propylene based elastomer, a plastomer, and an impact polypropylene-ethylene copolymer. The roofing membrane also may have a flame retardant. In a related exemplary embodiment, the total weight percent of the impact polypropylene-ethylene co-polymer present in the composition may range from about 7 to 20 percent.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a schematic fragmentary top plan view showing part of a multiple first and second roofing membrane sheet secured to an underlying deck structure; and

FIG. 2 is a side view of the coupling of two roofing membrane sheets.

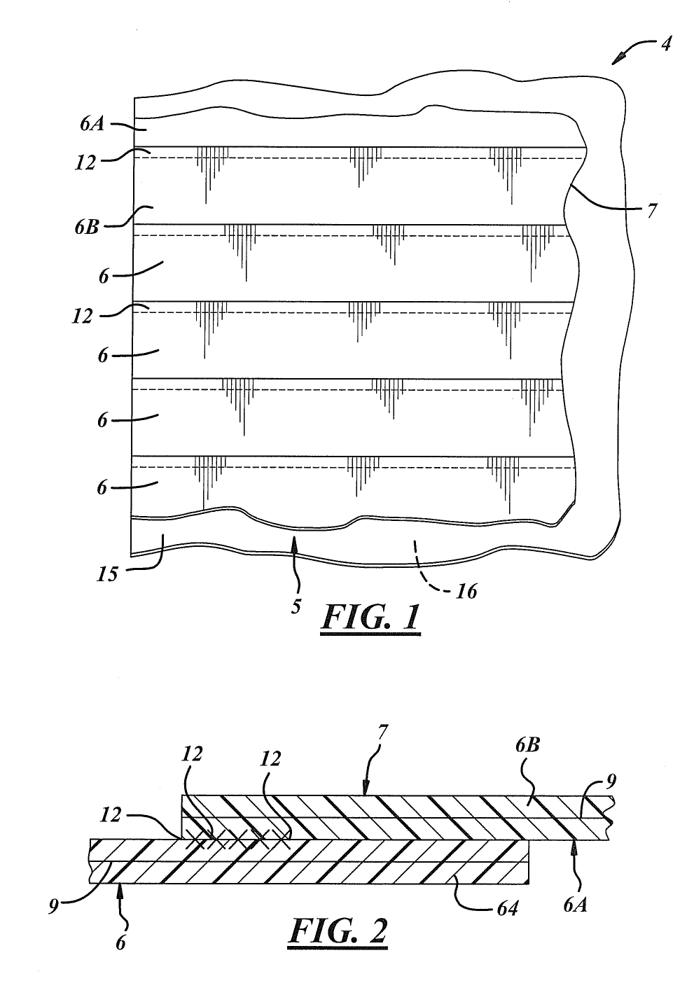

### DETAILED DESCRIPTION OF EXEMPLARY EMBODIMENTS

The following description of the embodiment(s) is merely exemplary (illustrative) in nature and is in no way intended to limit the invention, its application, or uses.

Referring now more particularly to the accompanying drawings, it should be understood that the roofing system 4 as secured on roof deck 5 is comprised of a series of heat weldable membranes, generally designated 6, which may be factory welded along their lapped edges to form the multiple membrane sheet, generally designated 7. In the attached Figures, an adjoining pair of such membranes 6 may be numbered generally as 6A and 6B. The factory weld or weld bond (shown as 12) can be accomplished in the factory under quality control conditions and may comprise a hot air weld affected by hot air which heats the membranes 6A and 6B at the edge of membranes 6A, 6B to a welding temperature wherein their contacting surfaces partially melt and form a weld bond of material. The weld bond 12 may also be created by a dielectric or radio frequency welding process, or other known heat welding or bonding methods. These “factory” welds are recognized to be more reliable than hot air field welds to achieve water-tight seams.

The sheet 7, comprised of multiple roofing membranes 6, welded in the manner disclosed in the factory, can be supplied to the roofer in rolled sheets of, for example, 2500 square feet in the weld bonded condition as shown in FIG. 2. Securement of the sheet 7 to the roof deck 5 can then take place progressively in a conventional manner using a combination of fasteners and other adhering means such as adhesives as is well known to those of ordinary skill in the art in the roofing industry. Alternatively, the membranes 6 may be welded together on-site using the afore-mentioned welding techniques.

The roof deck 5 can be comprised of many known surfaces or substrates, such as concrete, wood, asphalt, coal tar, steel, cement wood fiber and the like. The roof deck 5, for example, may be comprised of an insulation board or deck member 15 on a wood deck 16, which may be supported by suitable purlins or deck supporting structures in the conventional manner.

The membranes 6, in the exemplary embodiments, are thermoplastic membranes that are heat weldable as described above and provide sufficient flexibility, weatherability, reflectivity, retention, and flammability protection to the roof system 4. By way of non limiting example, the membranes 6 of the exemplary embodiments may be between about forty and eighty mils in thickness (0.040 to 0.080 inches) thick membranes. While a membrane thickness of 0.045 inches is common, typically a minimum acceptable thickness is 0.036 in. It will be appreciated that any suitable membrane thickness may be used within the scope of the present invention.

In another exemplary embodiment, as also shown in FIG. 2, a scrim 9 may be formed as a part of the membrane 6. In one example, the scrim 9 may be a thin sheet of woven polyester having a scrim density of about 14 to 18 threads per inch. The threads may be coated with a substance to prevent water from wicking up the threads. In another example, the scrim 9 optionally may instead or also include one or more fire retardant reinforcing threads. For instance, the thread may include a polyester thread copolymerized with a fire retardant additive, which may include SAL05 available from Performance Fibers of Salisbury, N.C. In one embodiment, the scrim 9 may include eighteen untreated polyester threads in a warp direction and, in the weft direction between nine and eighteen polyester threads copolymerized with a fire retardant additive. The scrim 9 may provide additional reinforcement to the membrane 6. It will be appreciated that any suitable scrim density and any suitable scrim material may be used within the scope of the present invention. Further, the membrane 6 may contain various reinforcing materials in the form of fibers or fabrics such as the aforementioned scrim. However, the reinforcing materials may take any suitable configuration.

The composition of the thermoplastic membrane 6, exclusive of the scrim 9, in one exemplary embodiment, includes a propylene based elastomer or thermoplastic polyolefin (TPO), a polyolefin elastomer or plastomer, and an impact polypropylene-ethylene copolymer, and may also include various additives related to processability, and heat and light stabilization. The membrane 6 may be extruded or otherwise formed into a thin sheet.

One exemplary formulation for the thermoplastic membrane 6 is provided in accordance with Formula I below; (In this formulation, the total polyolefin content is preferably greater than 50% of total composition by weight):

Formula I

| Material | % by weight |
|---|---|
| Propylene Based Elastomer | 30-50% |
| Plastomer | 9-20% |
| Impact Polypropylene-Ethylene | 7-20% |
| Copolymer | |
| Mg(OH)₂ (70% in Impact Polypropylene- | 20-35% |
| Ethylene Copolymer) | |
| TiO₂ (70% in Polyethylene) | 5-10% |
| Additives (e.g. Mono- or Di-Stearyl Acid | 1-2% |
| Phosphate; UV/Antioxidants) | |

Each of the percentages above and throughout the description herein is in terms of weight percent of the overall composition. The additives listed above may include processing aids that aid in the formation and storage of the membranes and additives that provide heat and light stabilization to the membrane during and after formation.

One suitable propylene based elastomer is VISTAMAXX® 6102 available from the Exxon Mobil Chemical Company. VISTAMAXX® 6102 is a Propylene/Ethylene Copolymer.

Suitable plastomers may include EXACT® 8201, grade 5008811, and/or EXACT® 9182X available from Exxon Mobil Chemical Co. of Houston, Tex.

An impact polypropylene-ethylene copolymer may also be used. Suitable impact polypropylene-ethylene copolymers may include T00G-00, T10GX00, and/or T10GX02 available from INEOS of League City, Tex., USA. The impact polypropylene-ethylene copolymer may be a low modulus impact polypropylene-ethylene copolymer.

Magnesium hydroxide may also be added. Magnesium hydroxide is readily available and may be pre-blended with an impact polypropylene-ethylene copolymer (of the type set forth above) to ensure complete dispersal in the composition. In one exemplary embodiment, the magnesium hydroxide is pre-blended with an impact polypropylene-ethylene copolymer as 70 weight percent magnesium hydroxide by weight and then dispersed into the composition. In another exemplary embodiment, the pre-blended magnesium hydroxide and impact polypropylene-ethylene copolymer material comprises between about 20 and 36 weight percent of the roofing membrane composition. The magnesium hydroxide may provide flame retardant properties.

The titanium dioxide is a white pigment added to the formulation to provide opacity and color. The titanium dioxide also may provide ultraviolet light protection as well. The titanium dioxide may be pre-blended with an impact polypropylene-ethylene copolymer (of the type set forth above) or polyethylene to ensure complete dispersal in the composition. To ensure complete dispersal of the titanium dioxide into the composition prior to extrusion or other formation techniques, it is preferable to introduce the titanium dioxide pre-blended with 30%, melt index of 12, low density polyethylene (LDPE).

The mono- or di-stearyl acid phosphate may be used as an additive for use as an anti-blocking agent and a lubricant. One suitable mono or di-stearyl acid phosphate is AX71 available from Asahi Denka Kogyo K.K. Its primary function is to allow the membranes 6 to be easily rolled onto, and unrolled from, a roller used to transport and store the formed membranes 6.

Other additives may include UV inhibitors which may be introduced to the composition to provide ultraviolet light protection to the formed membrane 6. In one exemplary embodiment, an UV inhibitor additive may be added for protecting the TPO component of the composition from ultraviolet light degradation. One exemplary UV/Antioxidant for the TPO component may be Tinuvin® XT-850 available from BASF (Formerly Ciba Specialty Chemicals) of Tarrytown, N.Y.

Still other additives may include antioxidant and/or thermal stabilizers. In an exemplary embodiment, processing and/or field thermal stabilizers may include IRGANOX® B-225 and/or IRGANOX® 1010 available from BASF.

The preferred total amount of polypropylene-ethylene copolymer (total contained in each of the listed components as well as any additional polypropylene-ethylene copolymer that may be added as necessary) in Formula I ranges from between about 7 to 20 weight percent.

While not explicitly stated, other additives and or materials may also be included in the formulations of the exemplary embodiments as is known in the art. For example, a hindered amine light stabilizer may be used as a portion of the light protection. Further, phenolic based antioxidants and long term thermal stabilizers may be used for process protection and extended service life. Moreover, fibrous materials or other reinforcing materials other than a scrim 9 may be included in the composition of the membrane 6 to provide additional durability. Further, other processing aids related to the method of manufacture, including solvents, diluents, and the like, may be included in the formulation to aid in extrusion. Also, other pigments or fillers or lubricants may be added as desired.

Another exemplary formulation for the thermoplastic membrane 6 is provided in accordance with Formula II below:

Formula II

| Material | % by weight |
|---|---|
| Propylene Based Elastomer | 32-48% |
| (e.g. VISTAMAXX ® 6102) | |
| Plastomer | 9-18% |
| (e.g. EXACT ® 8201, grade 5008811, | |
| and/or EXACT ® 9182X) | |
| Impact Polypropylene-Ethylene | 7-20% |
| Copolymer | |
| (e.g. T00G-00, T10GX00, and/or | |
| T10GX02) | |
| Magnesium Hydroxide | 25-35% |
| Titanium Dioxide | 4-6% |
| UV Inhibitor | 0.75 to 1.5% |
| (e.g. Tinuvin ® XT-850) | |
| Antioxidant/Stabilizer | 0.2 to 0.45% |
| (e.g. IRGANOX ® B-225) | |
| Thermal Stabilizer | 0.15 to 0.4% |
| (e.g. IRGANOX ® 1010) | |
| Lubricant | 0.1 to 0.2% |
| (e.g. Asahi AX71) | |

According to Formula II, the roofing membrane composition may include the flame retardant between about 25 and 35 weight percent of the composition, the pigment between about 4 and 6 weight percent of the composition, and additives between about 1.2 and 2.55 weight percent of the composition. As used herein, the term “about” accounts for typical manufacturing variation and tolerances.

To evaluate the improvement of the various properties that can be obtained in accordance with the technical teachings herein, several specimens of Formula II were fabricated for testing in accordance with ASTM D 6878 and various other physical property tests as specified in the tables below. Average values of the specimen tests are presented below in Tables 1 through 3.

TABLE 1

| | | Tearing | | Tearing | | | Modulus |
|---|---|---|---|---|---|---|---|
| Breaking | | Strength | | Strength | | | EMMAQUA |
| Strength | | (Tongue) | | (Trapezoid) | | Modulus | 668 MJ/m² |
| ASTM D 751 | | ASTM | | ASTM | | Initial | UV |
| Grab Method | | D 751 | | D 751 | | ASTM D 751 | |
| lbf | | lbf | | lbf | | Grab Method | |
| MD | CMD | MD | CMD | MD | CMD | psi | |
| 407 | 359 | 153 | 192 | 164 | 130.5 | 6293 | 4933 |

TABLE 2

| | | Elongation at | | Taber | Taber Stiffness |
|---|---|---|---|---|---|
| Shore A | Factory Seam | Break | | Stiffness | EMMAQUA |
| ASTM D- | Strength | ASTM D 751 | | ASTM | 742 MJ/m² UV |
| 2240 | ASTM D 751 | % | | D-5342 | ASTM D-5342 |
| Unitless | lbf | MD | CMD | Unitless | Unitless |
| 78.5 | 98.5 | 31.15 | 30.2 | 39.3 | 36.1 |

TABLE 3

| | Reflectivity | | Emissivity | OIT | |
|---|---|---|---|---|---|
| | EMMAQUA | | EMMAQUA | EMMAQUA | OIT |
| | 668 MJ/m² | | 668 MJ/m² | 98 MJ/m² UV | EMMAQUA |
| Reflectivity | UV | Emissivity | UV | (200° C.) | 668 MJ/m² UV |
| ASTM C- | ASTM C- | ASTM C- | ASTM C- | ASTM D- | (200° C.) |
| 1549 | 1549 | 1371 | 1371 | 3895 | ASTM D-3895 |
| % | % | % | % | minutes | minutes |
| 81.7 | 83.7 | 88 | 87 | 5 | 3.2 |

The presently disclosed roofing membrane composition and construction represents a unique roofing product that was optimized using significant variations in components from typical membrane formulations currently used in industry. The membrane was optimized to provide flexibility equal to or better than the assignee's current PVC roofing product. The presently disclosed membrane provides a wider weld window for prefabrication efficiency, demonstrates greater thermal stability, exhibits longer and more consistent reflectivity for cool roof parameters, and provides superlative flame resistance consistent with fire classifications not previously obtained in the industry for TPO roofing products.

Contributing to the flexibility of the membrane is a resin composition which exhibits an ethylene content higher than typical TPO membrane formulations. The composition deviates from typical TPO membrane formulations because it contains higher levels of ethylene copolymer (e.g. EXACT®) and ethylene-propylene rubber or elastomer polymers (e.g. VISTAMAXX®). With the addition of a specifically designed low melt flow polypropylene-ethylene copolymer impact modifiers (e.g. INEOS T series), the resulting material exhibits flexibility not otherwise achieved in industry. See Tables 1 and 2 above.

The concentration and variety of UV-inhibitors, thermal stabilizers, and anti-oxidants also may assist the material to exhibit significantly superior thermal stability. Superior thermal stability is directly correlatable to improved service life. See Table 3 above. Also, the unusually high levels of the additives or additive packages also may significantly contribute to the retention of reflectivity and emissivity properties and superior fire classification potential. See Table 3 above.

The above description of exemplary embodiments is merely exemplary in nature and, thus, variations thereof are not to be regarded as a departure from the spirit and scope of the invention.

What is claimed is:

1. A roofing membrane comprising:
a membrane composition including:
a propylene based elastomer;
a plastomer; and
an impact polypropylene-ethylene copolymer.

2. The roofing membrane of claim 1, wherein the impact polypropylene-ethylene copolymer content of the roofing membrane composition comprises between about 7 and 20 weight percent.

3. The roofing membrane of claim 1 wherein the membrane composition further includes a flame retardant additive.

4. The roofing membrane of claim 3, wherein the flame retardant additive comprises magnesium hydroxide.

5. The roofing membrane of claim 4, wherein the magnesium hydroxide is pre-blended with the impact polypropylene-ethylene copolymer and the pre-blended material comprises between about 20 and 36 weight percent of the roofing membrane.

6. The roofing membrane of claim 1 wherein the membrane composition further includes titanium dioxide.

7. The roofing membrane of claim 1 wherein the membrane composition further includes an anti-blocking agent and lubricant.

8. The roofing membrane of claim 1 wherein the membrane composition further includes an ultraviolet light and antioxidant stabilizer.

9. The roofing membrane of claim 1 wherein the membrane composition further includes an ultraviolet light and antioxidant stabilizer for stabilizing the propylene based elastomer.

10. The roofing membrane of claim 1 further comprising a scrim around which is formed the membrane composition.

11. The roofing membrane of claim 10 wherein the scrim includes at least one fire retardant reinforcing thread composed of polyester and copolymerized with a fire retardant additive.

12. The roofing membrane of claim 1 wherein the propylene based elastomer is between about 30 and 50 weight percent of the composition, the plastomer is between about 9 and 20 weight percent of the composition, and the impact polypropylene-ethylene copolymer is between about 7 and 20 weight percent of the composition.

13. The roofing membrane of claim 12 wherein the membrane composition further includes a flame retardant between about 20 and 35 weight percent of the composition, a pigment between about 5 and 10 weight percent of the composition, and additives between about 1 and 2 weight percent of the composition.

14. The roofing membrane of claim 1 wherein the propylene based elastomer is between about 32 and 48 weight percent of the composition, the plastomer is between about 9 and 18 weight percent of the composition, and the impact polypropylene-ethylene copolymer is between about 7 and 20 weight percent of the composition.

15. The roofing membrane of claim 14 wherein the membrane composition further includes a flame retardant between about 25 and 35 weight percent of the composition, a pigment between about 4 and 6 weight percent of the composition, and additives between about 1.2 and 2.55 weight percent of the composition.
